(19) United States
(12) Patent Application Publication
(10) Pub. No.: US 2021/0300120 A1
(43) Pub. Date: Sep. 30, 2021

(54) SHEAR BAND

(71) Applicant: The Goodyear Tire & Rubber Company, Akron, OH (US)

(72) Inventor: Francesco Sportelli, Bettembourg (LU)

(21) Appl. No.: 17/065,848

(22) Filed: Oct. 8, 2020

Related U.S. Application Data
(60) Provisional application No. 63/001,732, filed on Mar. 30, 2020.

(51) Int. Cl. B60C 7/10; B32B 5/02; B32B 25/10

(52) U.S. Cl. CPC B60C 7/10; B32B 5/024; B32B 2605/00; B32B 25/10; B32B 5/026

(57) ABSTRACT

A shear band for a tire includes a first fabric layer extending circumferentially around the tire, a second fabric layer extending circumferentially around the tire, and a spacer layer radially interposed between the first fabric layer and the second fabric layer. The first fabric layer and the second fabric layer each consist of multifilament yarns. The spacer layer consists of monofilament yarns.

### FIELD OF THE INVENTION

The present invention provides an improved shear band for use in non-pneumatic tires, pneumatic tires, and/or other technologies.

### BACKGROUND OF THE INVENTION

One conventional example relates to a structurally supported resilient tire supporting a load without internal air pressure. This non-pneumatic tire includes a ground contacting portion and side wall portions that extend radially inward from the tread portion and anchor in bead portions adapted to remain secure to a wheel during rolling of the wheel/tire. A reinforced annular shear band is disposed radially inward of the tread portion. This shear band includes at least one shear layer, a first membrane adhered to the radially inward extent of the shear layer and a second membrane adhered to the radially outward extent of the shear layer. Each of the membranes has a longitudinal tensile modulus sufficiently greater than the dynamic shear modulus of the shear layer so that, when under load, the ground contacting portion of the tire deforms to a flat contact region through shear strain in the shear layer while maintaining constant length of the membranes. Relative displacement of the membranes occurs substantially by shear strain in the shear layer.

Another conventional non-pneumatic tire includes an outer annular shear band and a plurality of web spokes that extend transversely across and radially inward from the shear band and are anchored in a wheel or hub. The shear band may comprise an annular shear layer, a first membrane adhered to the radially inward extent of the shear layer, and a second membrane adhered to the radially outward extent of the shear layer. Under load, this shear band deforms in the contact area with the ground surface through a mechanism that includes shear deformation of the shear band.

As described above, a shear band may provide desirable performance benefits in a tire. As described below, the shear band in accordance with the present invention may further enhance performance capabilities of the tire. This improved construction for the shear band may have application in pneumatic tires, nonpneumatic tires, and other products as well.

### SUMMARY OF THE INVENTION

A shear band for a tire in accordance with the present invention includes a first fabric layer extending circumferentially around the tire, a second fabric layer extending circumferentially around the tire, and a spacer layer radially interposed between the first fabric layer and the second fabric layer. The first fabric layer and the second fabric layer each consist of multifilament yarns. The spacer layer consists of monofilament yarns.

According to another aspect of the shear band, the first fabric layer is secured to the spacer layer.

According to still another aspect of the shear band, the second fabric layer is secured to the spacer layer.

According to yet another aspect of the shear band, a first rubber layer is secured to a radially outer surface of the first fabric layer.

According to still another aspect of the shear band, a second rubber layer is secured to a radially inner surface of the second fabric layer.

According to yet another aspect of the shear band, the first fabric layer contains only multifilament yarns.

According to still another aspect of the shear band, the second fabric layer contains only multifilament yarns.

According to yet another aspect of the shear band, the spacer layer contains only monofilament yarns.

According to still another aspect of the shear band, the first fabric layer forms a pattern having hexagonal vacant spaces.

According to yet another aspect of the shear band, the second fabric layer forms a pattern having hexagonal vacant spaces.

A method in accordance with the present invention constructs or fabricates a shear band for a tire. The method incudes the steps of: defining a first fabric layer with multifilaments; securing a first rubber layer to the first fabric layer; defining a second fabric layer with multifilaments; securing a second rubber layer to the first fabric layer; defining a spacer layer with monofilaments; securing the first fabric layer to a first part of the spacer layer; and securing the second fabric layer a second part of the spacer layer.

According to another aspect of the method, a further step includes knitting the first part of the spacer layer to the first fabric layer.

According to still another aspect of the method, a further step includes knitting the second part of the spacer layer to the second fabric layer.

According to yet another aspect of the method, a further step includes weaving the first part of the spacer layer to the first fabric layer.

According to still another aspect of the method, a further step includes weaving the second part of the spacer layer to the second fabric layer.

### Definitions

As used herein and in the claims:

“Adhering” means binding one item to another item by glue, weld, friction, mechanical engagement, fusion, and/or other method of cohesion.

“Apex” means an elastomeric filler located radially above the bead core and between the plies and the turnup ply.

“Annular” means formed like a ring.

“Aramid” and “Aromatic polyamide” both mean a manufactured fiber in which the fiber-forming substance is generally recognized as a long chain of synthetic aromatic polyamide in which at least 85% of the amide linkages are attached directly to the two aromatic rings. Representative of an aramid or aromatic polyamide is a poly (p-phenyleneterephthalamide).

“Aspect ratio” means the ratio of a tire section height to its section width. For example, the aspect ratio may be the maximum axial distance between the exterior of the tire sidewalls when unloaded and inflated at normal pressure, multiplied by 100% for expression as a percentage. Low aspect ratio may mean a tire having an aspect ratio of 65 and below.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Braided tube” means a tubular structure including a cord/filament/strand/strip with usually three or more component strands forming a regular diagonal pattern down its length. The tube structure may be a narrow, ropelike band formed by plaiting or weaving together several strands. Braiding may result in an interlaced fabric tube with crossing strips laid together in diagonal formation thereby forming a narrow strip of tubular fabric, which may be flattened to form a flattened tube strip and/or layer.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Composite”, as used herein, means constructed from two or more layers.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Cord twist” means each yarn of the cord has its component filaments twisted together a given number of turns per unit of length of the yarn (usually expressed in turns per inch (TPI) or turns per meter (TPM)) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S”, then the twist is called “S” or “left hand”. If the slope of the spirals conforms in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “dtex” is understood to mean the weight in grams of 10,000 meters of a yarn before the yarn has a twist imparted thereto.

“Cut belt ply” refers to a belt having a width less than the tread width, which lies flat over the carcass plies in the crown area of the tire.

“Crown” means that portion of the tire in the proximity of the tire tread.

“Denier” means the weight in grams per 9000 meters (unit for expressing linear density). “Dtex” means the weight in grams per 10,000 meters.

“Density” means weight per unit length.

“Dynamic shear modulus” means the shear modulus measured per ASTM D5992.

“Elastomer” means a resilient material capable of recovering size and shape after deformation.

“Elongation at break” means the tensile elongation as measured by ASTM D412-98a and conducted at 100° C. rather than ambient.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Hysteresis” means a dynamic loss tangent (e.g., max tan delta). The dynamic characteristics of the materials are measured on an MTS 831 Elastomer Test System in accordance with ASTM D5992. The response of a sample of vulcanized material (cylindrical test piece of a thickness of 4 mm and a section of 400 mm²), subjected to an alternating single sinusoidal shearing stress, at a frequency of 10 Hz and at 80° C., is recorded. Scanning is conducted at an amplitude of deformation of 0.1 percent to 50 percent (outward cycle), then of 50 percent to 0.1 percent (return cycle). The maximum shear modulus G max in MPa and the maximum value of the tangent of the loss angle tan delta (max tan delta) is determined during the outward cycle.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“Knitting” means a method by which yarn is manipulated to create a textile or fabric. Knitting may create multiple loops of yarn, called stitches, in a line or a tube. Knitted fabric may consist of a number of consecutive rows of intermeshing loops.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Modulus” of a test specimen means the tensile modulus of elasticity at 1 percent elongation in the circumferential direction of the tire multiplied by the effective thickness of the test specimen.

“Mega tensile steel (MT)” means a carbon steel with a tensile strength of at least 4500 MPa at 0.20 mm filament diameter.

“Meridian plane” means a plane parallel to the axis of rotation of the tire and extending radially outward from the axis.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” means stress expressed as force per unit linear density of the unstrained specimen (gm/tex or gm/denier).

“Tensile stress” is force expressed in force/cross-sectional area. Strength in psi=12,800 times specific gravity times tenacity in grams per denier.

“Tension” for a cord means force on the cord expressed as mN/tex.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turns per inch”, or TPI, means turns of cord twist for each inch length of cord.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Weaving” means a method of textile production in which two distinct sets of yarns or threads are interlaced at right angles to form a fabric or layer. The longitudinal yarns or threads may be called the warp and the lateral yarns or threads may be called weft or filling.

“Wheel” or “hub” means a structure for supporting the tire and mounting to the vehicle axle.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

A full and enabling disclosure of examples of the present invention, directed to one of ordinary skill in the art, is set forth in the specification with reference to the appended figures, in which:

FIG. 1 is a schematic perspective view of part of an example shear band in accordance with the present invention.

FIG. 2 is schematic top view of the part of FIG. 1.

FIG. 3 is a schematic cross section view taken along line “3-3” in FIG. 1 of the complete shear band.

FIG. 4 is a schematic cross section view taken along line “4-4” in FIG. 1 of the complete shear band.

Similar numerals refer to similar parts throughout the drawings.

### DETAILED DESCRIPTION OF EXAMPLES OF THE PRESENT INVENTION

Reference will now be made in detail to examples of the present invention, one or more examples of which are illustrated in the figures. These examples may be used in tires, such as described in the example tire of U.S. Pat. No. 10,071,603, incorporated herein by reference in its entirety. Each example is provided by way of explanation of the present invention, and not meant as a limitation of the present invention. For example, features illustrated or described as part of one example may be used with another example to yield still a third example. It is intended that the present invention include these and other modifications and variations. It should be noted that for the purposes of discussion, only part of example tires may be depicted in one or more of the figures. One of ordinary skill in the art, using the teachings disclosed herein, will understand that the same or substantially similar features may be repeated in other parts the example tires.

The present invention provides an improved shear band that may be used in a variety of products including, for example, non-pneumatic tires, pneumatic tires, and/or other technologies. The improved shear band may be constructed as a composite comprised of individual knitted layers, which may be, in turn, constructed from certain materials having specific physical properties that, when combined in a particular manner as described herein, may provide overall physical properties and performance characteristics desirably exceeding that which would be obtained from a shear band constructed from only one of the individual materials. By way of example only, improvements in rolling resistance and tire design flexibility may be obtained.

In accordance with the present invention, shear band materials of conventional rubber compounds may be replaced by ultra-light, three-dimensional, knitted fabric layers, as described herein. In other applications, computerized weft and warp machines may develop three-dimensional textiles with improved physical, thermal, and/or mechanical properties. These textiles may be used in aerospace, automobile, geotechnical, marine, medical, and/or other applicable industries. Within this family of textiles, knitted three-dimensional fabrics may define a structure of two independent top and bottom layers (also called skins) interconnected, but kept apart, by a spacer layer. This type of structure may be manufactured by weft or warp knitting, with warp knitting being most common. During a knitting cycle, the top and bottom layers may be knitted simultaneously using a double-needle machine.

In accordance with the present invention, knitted multifilament yarns may define the top and bottom layers, while monofilament yarns (or piles) may define the spacer layer. The shear band may further comprise a first rubber layer secured to the top layer and a second rubber layer secured to the bottom layer. The shear band may be split at intervals by a material, such as polyurethane or similar fibers. The thickness of the shear band may be between 7.0 mm and 10.0 mm. The multifilament yarns of the top and bottom layers and the monofilament yards of the spacer layer may be formed of polyester or other suitable material.

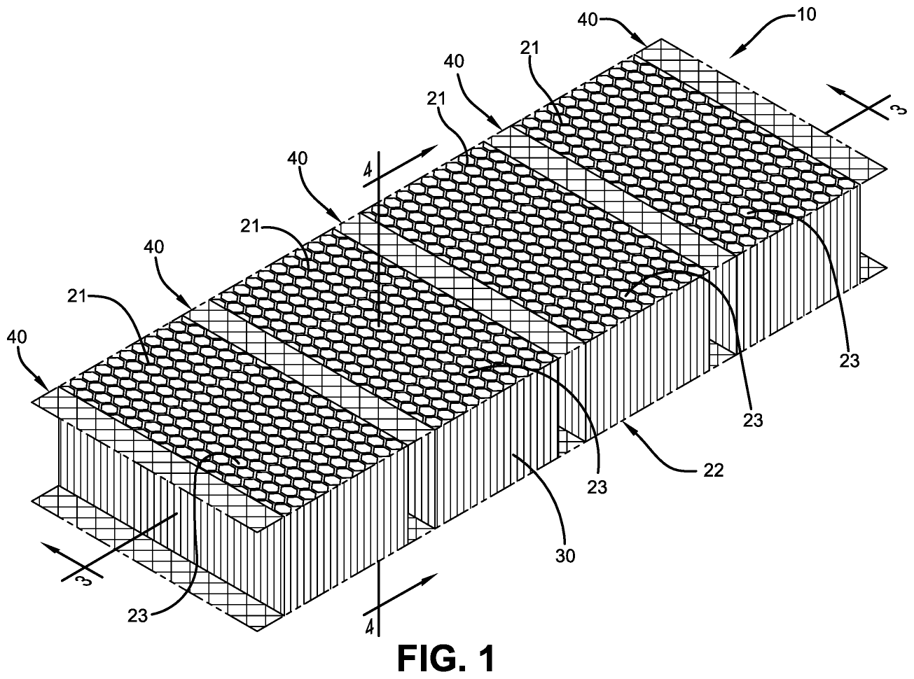

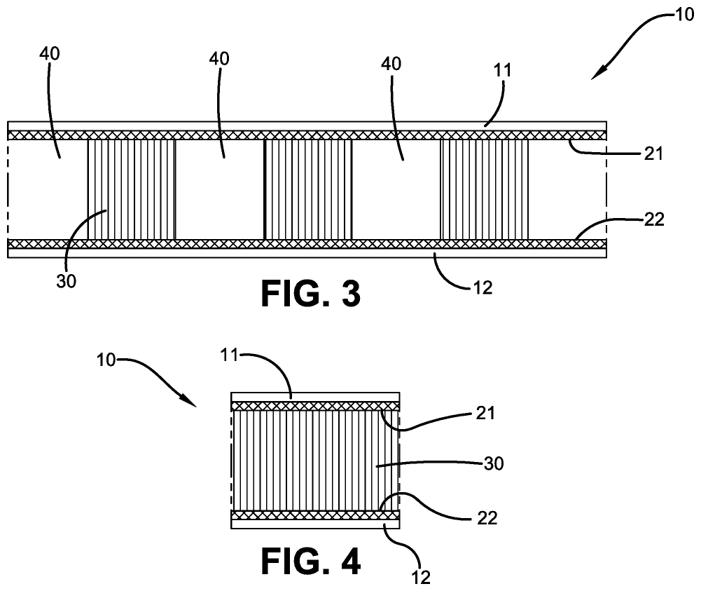

As shown in FIGS. 1-4, an example shear band 10 in accordance with the present invention may include a first top rubber layer 11 (FIGS. 3-4), a first top fabric layer 21 secured to the first top rubber layer, a second bottom rubber layer 12 (FIGS. 3-4), a second bottom fabric layer 22 secured to the second bottom rubber layer, and a spacer layer 30 radially interconnecting the first top fabric layer and the second bottom fabric layer. The layers 11, 12, 21, 22, 30 may be split into regular parts by longitudinal spacer sections 40 of elastic polyurethane and/or other suitable material.

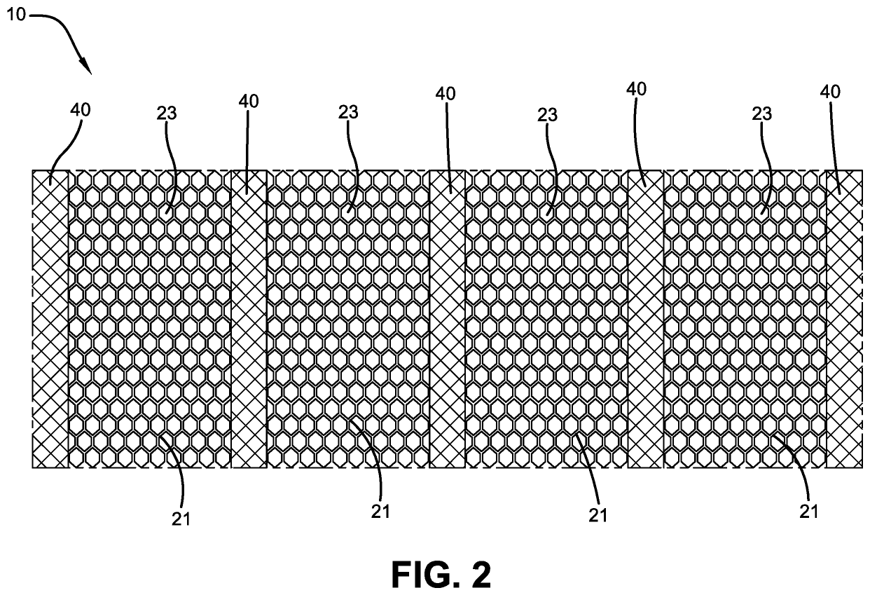

The first top fabric layer 21 and the second bottom fabric layer 22 may be constructed of multifilament yarns of suitable material. Multifilament yarns may be composed of continuous filaments aligned in parallel rows which run straight except when they are coiled by the insertion of a twist, giving the yarns an appearance of evenness or smoothness and an absence of hairiness. Most of the filaments may not require sizing. However, sizing may improve their efficiency by a further 15-20%. Sizing may improve frictional resistance of the yarn and may bond the filaments preventing peeling back and intermingling of any broken filaments which are present on the yarn before weaving or may break during weaving. In order to achieve this, the selected size of the filaments may have sufficient adhesion to the fibers to make the filaments cohere. The multifilament yarns may form a pattern with vacant spaces 23 (FIGS. 1-2) for reducing weight. The vacant spaces 23 may be any suitable shape, such as hexagonal (FIGS. 1-2), square, orthogonal, nonogonal, triangular, etc.

The spacer layer 30 may be constructed of monofilament yarns of suitable material. Monofilament yarns may consist of a single solid filament. Monofilament yarns may be circular and solid in cross section. The shape of the filament may be altered to produce noncircular filaments, hollow filaments, and/or other shaped monofilaments. The diameter range of monofilament yarns may be between 100.0 μm and 2000.0 μm. Examples of monofilament yarns may include fishing line, dental floss, sport racquet strings, bristles of tooth brushes, and/or other suitable uses. Hollow monofilaments may be used in softer sewing thread applications while elastomeric monofilaments may find applications in pressure layers, such as the spacer layer 30. The monofilaments of the spacer layer 30 may be attached to the fabric layers 21, 22 in any suitable manner, such as knitting or weaving the monofilaments directly into the fabric layers.

One of ordinary skill in the art will understand that numerous examples of the present invention may be created that fall within the present disclosure and claims that follow. It should be understood that the present invention includes various modifications that may be made to the examples described herein that come within the scope of the appended claims and their equivalents, as determined by one of ordinary skill in the art.

What is claimed:

1. A shear band for a tire comprising:
a first fabric layer extending circumferentially around the tire;
a second fabric layer extending circumferentially around the tire; and
a spacer layer radially interposed between the first fabric layer and the second fabric layer, the first fabric layer and the second fabric layer each consisting of multifilament yarns, the spacer layer consisting of monofilament yarns.

2. The shear band as set forth in claim 1 wherein the first fabric layer is secured to the spacer layer.

3. The shear band as set forth in claim 1 wherein the second fabric layer secured to the spacer layer.

4. The shear band as set forth in claim 1 further including a first rubber layer secured to a radially outer surface of the first fabric layer.

5. The shear band as set forth in claim 4 further including a second rubber layer secured to a radially inner surface of the second fabric layer.

6. The shear band as set forth in claim 1 wherein the first fabric layer contains only multifilament yarns.

7. The shear band as set forth in claim 6 wherein the second fabric layer contains only multifilament yarns.

8. The shear band as set forth in claim 1 wherein the spacer layer contains only monofilament yarns.

9. The shear band as set forth in claim 1 wherein the first fabric layer forms a pattern having hexagonal vacant spaces.

10. The shear band as set forth in claim 1 wherein the second fabric layer forms a pattern having hexagonal vacant spaces.

11. A method for constructing a shear band for a tire, the method comprising the steps of:
defining a first fabric layer with multifilaments;
securing a first rubber layer to the first fabric layer;
defining a second fabric layer with multifilaments;
securing a second rubber layer to the first fabric layer;
defining a spacer layer with monofilaments;
securing the first fabric layer to a first part of the spacer layer; and
securing the second fabric layer a second part of the spacer layer.

12. The method as set forth in claim 11 further including the step of knitting the first part of the spacer layer to the first fabric layer.

13. The method as set forth in claim 11 further including the step of knitting the second part of the spacer layer to the second fabric layer.

14. The method as set forth in claim 11 further including the step of weaving the first part of the spacer layer to the first fabric layer.

15. The method as set forth in claim 11 further including the step of weaving the second part of the spacer layer to the second fabric layer.

16. The method as set forth in claim 11 further including the step of adhering the first part of the spacer layer to the first fabric layer.

17. The method as set forth in claim 11 further including the step of adhering the second part of the spacer layer to the second fabric layer.

18. The shear band as set forth in claim 11 further including the step of knitting the first part of the spacer layer to the first fabric layer.

19. The shear band as set forth in claim 12 further including the step of adhering the second part of the spacer layer to the second fabric layer.

20. The shear band as set forth in claim 12 further including the step of weaving the second part of the spacer layer to the second fabric layer.
